(19) United States
(12) Patent Application Publication
(10) Pub. No.: US 2009/0029840 A1
(43) Pub. Date: Jan. 29, 2009

(54) CORRUGATING MACHINE

(76) Inventor: Jung Chi CHEN, Yingge Township (TW)

Correspondence Address: BIRCH STEWART KOLASCH & BIRCH, PO BOX 747, FALLS CHURCH, VA, 22040-0747, US

(21) Appl. No.: 11/782,424

(22) Filed: Jul. 24, 2007

(51) Int. Cl. B31F 1/20

(52) U.S. Cl. 493/463

(57) ABSTRACT

A corrugating machine includes a bed, a first rolling mechanism arranged on one side of the bed and including a plurality of longitudinal flute forming roll sets; and a second rolling mechanism arranged on another side of the bed and including a corrugating roll, a transverse flute forming roll and a toothed roll respectively located at an upper and a lower position at one side of the corrugating roll to mesh with the corrugating roll, a glue spraying unit located between the corrugating roll and the transverse flute forming roll, and a smooth roll and an adhesive dispensing unit respectively located at an upper and a lower position at another side of the corrugating roll. At least three plies of work material may be rolled, fluted, embossed, and bonded together using the two rolling mechanisms to thereby provide enhanced structural strength and improved damping effect.

### FIELD OF THE INVENTION

The present invention relates to a corrugating machine, and more particularly to a corrugating machine, with which at least three plies of work material may be rolled using two rolling mechanisms of the corrugating machine to form desired corrugations and bond together to thereby provide enhanced structural strength and improved damping effect.

### BACKGROUND OF THE INVENTION

Generally, a conventional corrugated paper forming machine includes a plurality of rolls, a glue dispensing device, a heating device, and a conveying device, so that two webs of paper are continuously supplied into the machine to be roll formed, glued, bonded, dried, and finally conveyed out of the machine to provide a finished product of single corrugated board.

While the conventional corrugated paper forming machine may be used to produce a single corrugated board from two webs of continuous paper, only one of the two webs of paper can be rolled to form desired corrugation thereon and then bonded to the other web of paper to complete a single corrugated board. Therefore, an article made of the single corrugated board so produced with the conventional corrugating machine has relatively low structural strength and damping effect, and might not be strong enough in practical use thereof.

### SUMMARY OF THE INVENTION

A primary object of the present invention is to provide a corrugating machine, so that at least three plies of work material may be rolled using two rolling mechanisms of the corrugating machine to form desired corrugations and bond together to thereby provide enhanced structural strength and improved damping effect.

To achieve the above and other objects, the corrugating machine according to the present invention includes a bed; a first rolling mechanism arranged on one side of the bed, and including a plurality of longitudinal flute forming roll sets, each of which includes two vertically correspondingly arranged rolls; and a second rolling mechanism arranged on another side of the bed opposite to the first rolling mechanism, and including a corrugating roll, a transverse flute forming roll and a toothed roll respectively located at an upper and a lower position at one side of the corrugating roll facing toward the first rolling mechanism to mesh with the corrugating roll, a glue spraying unit located between the corrugating roll and the transverse flute forming roll, and a smooth roll and an adhesive dispensing unit respectively located at an upper and a lower position at another side of the corrugating roll facing away from the first rolling mechanism.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a phantom view of a corrugating machine according to a preferred embodiment of the present invention;

FIG. 2 is a sectioned side view of FIG. 1;

FIG. 3 is a fragmentary and enlarged sectional view of a longitudinal flute forming roll set included in the present invention;

FIG. 4 is a fragmentary and enlarged view of a toothed roll included in the present invention;

FIG. 5 shows the operating manner of the present invention;

FIG. 6 shows a first work material with longitudinal flutes roll formed thereon using the corrugating machine of the present invention;

FIG. 7 shows a second work material with transverse flutes roll formed thereon using the corrugating machine of the present invention;

FIG. 8 shows the bonded and embossed first and second work material; and

FIG. 9 shows the bonding of the bonded and embossed first and second work material to a third work material.

### DETAILED DESCRIPTION OF THE PREFERRED EMBODIMENTS

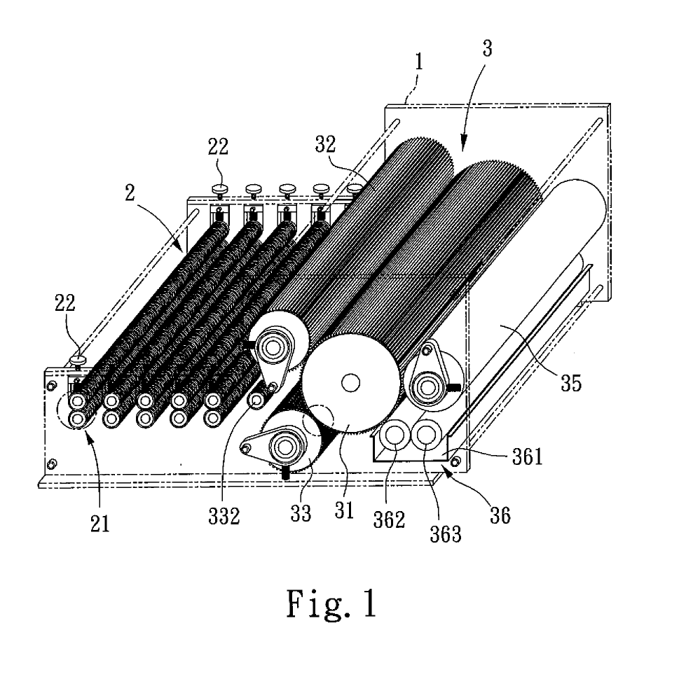

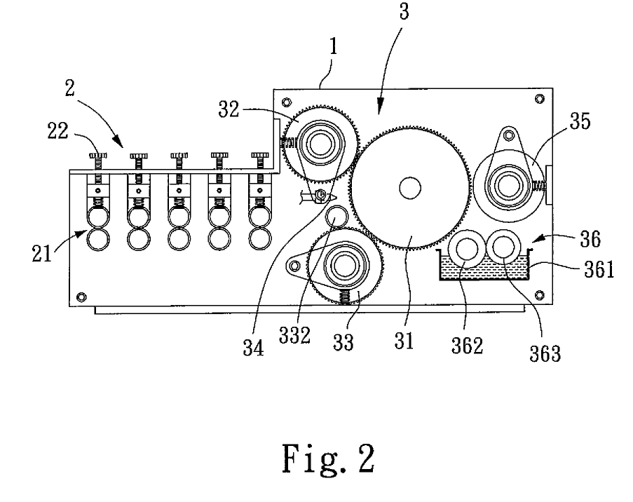

Please refer to FIGS. 1 and 2 that are phantom and sectioned side views, respectively, of a corrugating machine according to the present invention. As shown, the corrugating machine of the present invention includes a bed 1, a first rolling mechanism 2, and a second rolling mechanism 3, so that at least three work materials may be rolled to form desired corrugations and bonded together by the two rolling mechanisms 2, 3 to provide increased structural strength and improved damping effect.

The bed 1 may be connected to a front-end and a rear-end process (not shown) depending on actual need.

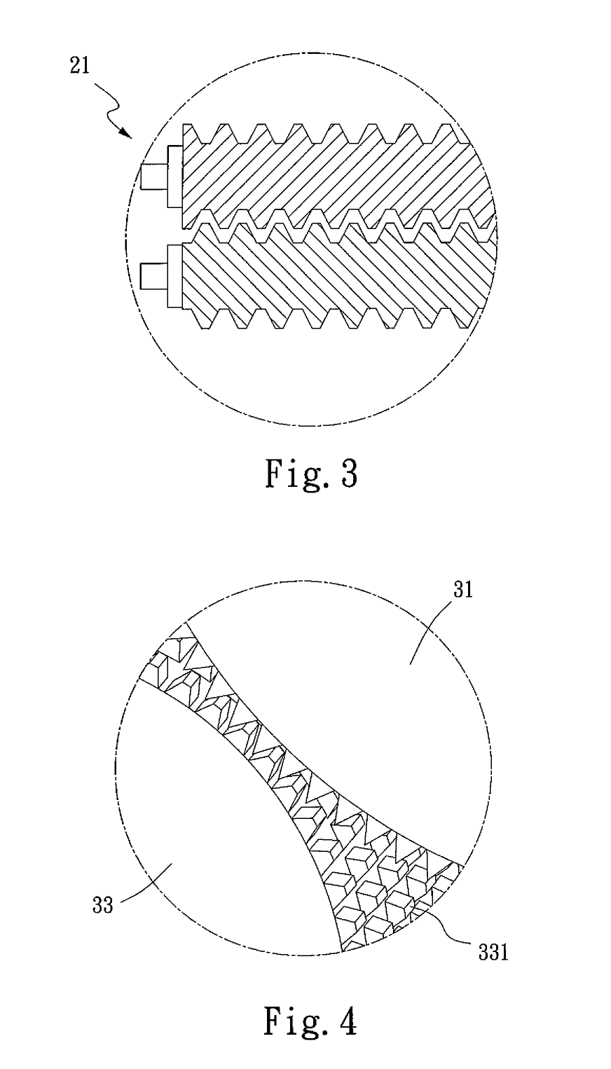

The first rolling mechanism 2 is arranged on one side of the bed 1, and includes at least a plurality of longitudinal flute forming roll sets 21 each of which includes two vertically correspondingly arranged rolls and is provided with a cooperative adjusting unit 22. FIG. 3 is a fragmentary and enlarged sectional view of one longitudinal flute forming roll set 21.

The second rolling mechanism 3 is arranged on another side of the bed 1 opposite to the first rolling mechanism 2, and includes at least a corrugating roll 31, a transverse flute forming roll 32 and a toothed roll 33 respectively located at an upper and a lower position at one side of the corrugating roll 31 facing toward the first rolling mechanism 2 to mesh with the corrugating roll 31, a glue spraying unit 34 located between the corrugating roll 31 and the transverse flute forming roll 32, and a smooth roll 35 and an adhesive dispensing unit 36 respectively located at an upper and a lower position at another side of the corrugating roll 31 facing away from the first rolling mechanism 2.

FIG. 4 is a fragmentary and enlarged view of the toothed roll 33. As shown, the toothed roll 33 is provided on a roll surface thereof with a plurality of radially outward extended and upward tapered teeth 331, and works in cooperation with a pulley 332.

The adhesive dispensing unit 36 includes a tank 361 for containing an amount of adhesive therein, and an adhesive dispensing roll 362 and an adhesive scraping roller 363 correspondingly arranged in the tank 361 to contact with each other.

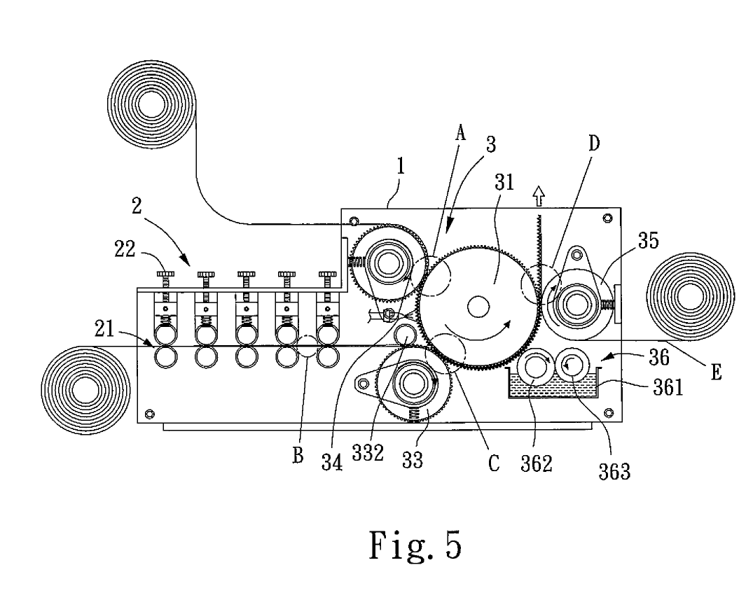

Please refer to FIG. 5 that is a sectioned side view showing the operating manner of the corrugating machine of the present invention. As shown, when the corrugating machine operates, a first work material 4 is supplied through the longitudinal flute forming roll sets 21 of the first rolling mechanism 2, a second work material 4a is supplied to pass between the corrugating roll 31 and the transverse flute forming roll 32 of the second rolling mechanism 3, and a third work material 4b is supplied to pass between the corrugating roll 31 and the smooth roll 35. The first, the second, and the third work material 4, 4a, and 4b may be paper, plastic materials, or metal materials. Before the longitudinal flute forming roll sets 21 are actuated to operate, a clearance, or relative height, between the two rolls of each longitudinal flute forming roll set 21 may be adjusted with the cooperative adjusting unit 2 thereof based on a thickness of the first work material 4 or a preset roll pressure of the roll sets 21; or the number of the longitudinal flute forming roll sets 21 may be increased or decreased so that a fixed roll clearance most suitable for rolling the first work material 4 is set for all the longitudinal flute forming roll sets 21; or the roll clearance is gradually reduced from the beginning one to the last one of the longitudinal flute forming roll sets 21, so that the roll pressure applied to the first work material 4 is buffered and the rolling could be smoothly performed without damaging the first work material 4. Similarly, a relative clearance between the transverse flute forming roll 32 and the corrugating roll 31 may be adjusted based on a thickness of the second work material 4a or a preset roll pressure therefor.

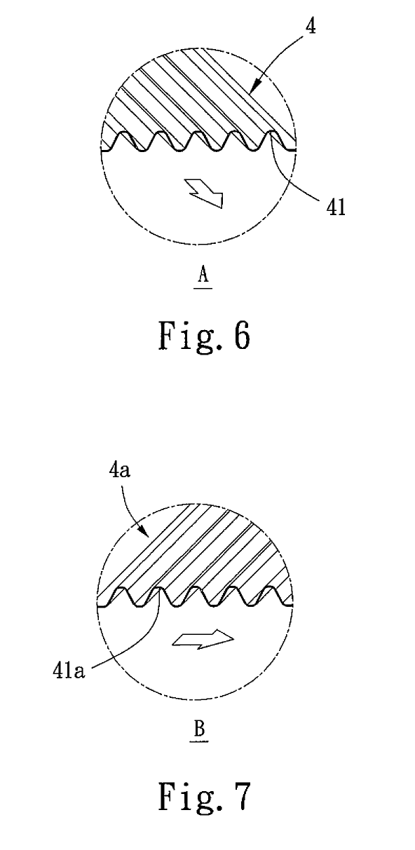

When the bed 1 is actuated for the first and the second rolling mechanism 2, 3 to operate, the first work material 4 passed through the longitudinal flute forming roll sets 21 is rolled to form longitudinal flutes 41 thereon, as shown in FIG. 6; and the second work material 4a passed between the corrugating roll 31 and the transverse flute forming roll 32 is rolled to form transverse flutes 41a thereon, as shown in FIG. 7.

The longitudinally fluted first work material 4 is kept moving forward to first pass between the toothed roll 33 and the pulley 332 and then passes between the toothed roll 33 and the corrugating roll 31. Meanwhile, the transversely fluted second work material 4a passes the glue spraying unit 34 and is coated with a layer of glue before moving forward to pass between the toothed roll 33 and the corrugating roll 31. Therefore, the first work material 4 with the longitudinal flutes 41 and the second work material 4a with the transverse flutes 41a overlap each other between the toothed roll 33 and the corrugating roll 31 and are bonded together under the roll pressure from the two rolls 33 and 31.

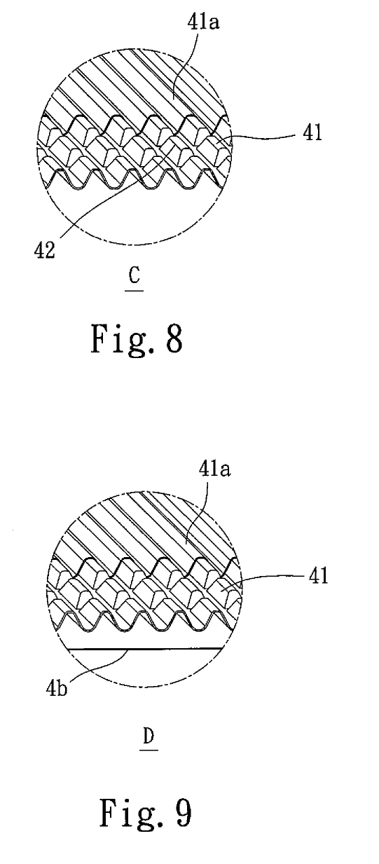

Meanwhile, due to the tapered teeth 331 on the roll surface of the toothed roll 33, the first and the second work materials 4, 4a bonded together between the rolls 33 and 31 are embossed at the same time to form a plurality of tapered protrusions 42 thereon, as shown in FIG. 8.

The bonded and embossed first and second work material 4, 4a is kept moving forward to pass the adhesive dispensing roll 362 of the adhesive dispensing unit 36 and be coated with a layer of adhesive before moving into a clearance between the corrugating roll 31 and the smooth roll 35. Meanwhile, the third work material 4b is moved forward to pass between the corrugating roll 31 and the smooth roll 35 and thereby bonded to the previously bonded, embossed, and adhesive coated first and second work material 4, 4a, as shown in FIG. 9.

The fully bonded first, second, and third work material 4, 4a, 4b is then subjected to subsequent drying and winding process (not shown) to thereby provide an enhanced structural strength and improved damping effect.

With the above arrangements, the corrugating machine of the present invention effectively overcomes the drawbacks in the prior art by using first and second rolling mechanisms to roll, flute, corrugate, and bond at least three plies of work material, so that the finally produced material has enhanced structural strength and improved damping effect to ensure practical and valuable use thereof.

1. A corrugating machine, comprising:
a bed;
a first rolling mechanism arranged within one side of the bed, and including a plurality of longitudinal flute forming roll sets, each of which includes two vertically correspondingly arranged rolls; and
a second rolling mechanism arranged within another side of the bed opposite to the first rolling mechanism, and including a corrugating roll, a transverse flute forming roll and a toothed roll respectively located at an upper and a lower position at one side of the corrugating roll facing toward the first rolling mechanism to mesh with the corrugating roll, a glue spraying unit located between the corrugating roll and the transverse flute forming roll, and a smooth roll and an adhesive dispensing unit respectively located at an upper and a lower position at another side of the corrugating roll facing away from the first rolling mechanism, the smooth roll being downstream from the longitudinal flute forming roll sets.

2. The corrugating machine as claimed in claim 1, wherein the plurality of longitudinal flute forming roll sets are provided with a cooperative adjusting unit each.

3. The corrugating machine as claimed in claim 1, wherein the toothed roll is provided on a roll surface thereof with a plurality of upward tapered teeth.

4. The corrugating machine as claimed in claim 1, further comprising a pulley cooperating with the toothed roll.

5. The corrugating machine as claimed in claim 1, wherein the adhesive dispensing unit includes a tank for containing an amount of adhesive therein, and an adhesive dispensing roll and an adhesive scraping roll correspondingly arranged in the tank to contact with each other.

6. The corrugating machine as claimed in claim 1, wherein the corrugating roll is surrounded by the transverse flute forming roll, the toothed roll and the smooth roll.

7. The corrugating machine as claimed in claim 6, wherein the corrugating roll has an axis of rotation and wherein an outer periphery of the transverse flute forming roll, the toothed roll and the smooth roll are a same distance from the axis of rotation of the corrugating roll.

8. The corrugating machine as claimed in claim 1, wherein the corrugating roll has an axis of rotation and wherein an outer periphery of the transverse flute forming roll and the smooth roll are a same distance from the axis of rotation of the corrugating roll.

9. The corrugating machine as claimed in claim 1, wherein the corrugating roll has an axis of rotation and wherein an outer periphery of the toothed roll and the smooth roll are a same distance from the axis of rotation of the corrugating roll.

10. The corrugating machine as claimed in claim 1, wherein the transverse flute forming roll is upstream from the toothed roll.

11. The corrugating machine as claimed in claim 10, wherein the plurality of longitudinal flute forming roll sets are upstream from the toothed roll and the smooth roll.

12. The corrugating machine as claimed in claim 1, wherein the adhesive dispensing unit is downstream from the toothed roll.

13. The corrugating machine as claimed in claim 12, wherein the glue spraying unit is upstream of the toothed roll and downstream of the transverse flute forming roll.

14. The corrugating machine as claimed in claim 1, wherein the plurality of longitudinal flute forming roll sets include more than two sets with each set having at least two rolls.

15. The corrugating machine as claimed in claim 14, wherein the plurality of longitudinal flute forming roll sets are linearly arranged with a feed path passing between each set of rolls, the feed path lying along an axis which axis intersects a center of the corrugating roll.

16. The corrugating machine as claimed in claim 1, wherein the transverse flute roll meshes with the corrugating roll and wherein the toothed roll meshes with the corrugating roll.
